(19) United States
(12) Patent Application Publication
(10) Pub. No.: US 2023/0311250 A1
(43) Pub. Date: Oct. 5, 2023

(54) COPPER SINTERING PASTE COMPOSITION AND METHOD OF PREPARING SAME

(71) Applicant: Hojeonable Inc., Daejeon (KR)

(72) Inventors: Jong Tae Moon, Gyeryong-si (KR); Kwang Mo Jung, Gunpo-si (KR)

(73) Assignee: Hojeonable Inc., Daejeon (KR)

(21) Appl. No.: 18/129,163

(22) Filed: Mar. 31, 2023

(30) Foreign Application Priority Data
Apr. 1, 2022 (KR) 10-2022-0041153

(51) Int. Cl. B23K 35/30; B23K 35/36; B22F 1/05; B22F 1/102; B22F 1/145; B22F 1/107; B23K 35/365

(52) U.S. Cl. CPC B23K 35/302; B23K 35/3613; B22F 1/05; B22F 1/102; B22F 1/147; B22F 1/107; B23K 35/365; B22F 2999/00; B22F 2998/10; B22F 2302/45; B22F 2301/10

(57) ABSTRACT

Proposed are a copper sintering paste composition and a method of preparing the same. The copper sintering paste composition can replace conventional bonding material such as solder and lead-free solder and has excellent heat resistance, heat-generating properties, thermal conductivity, and bonding strength.

### CROSS REFERENCE TO RELATED APPLICATION

The present application claims priority to Korean Patent Application No. 10-2022-0041153, filed Apr. 1, 2022, the entire contents of which is incorporated herein for all purposes by this reference.

### BACKGROUND OF THE DISCLOSURE

### 1. Field of the Disclosure

The present disclosure relates to a copper sintering paste composition for copper sinter bonding, a method of preparing the same, and copper sinter bonding formed from the composition.

### 2. Description of the Related Art

Conventionally, a variety of bonding materials are used to bond a semiconductor device to a support member. As such bonding materials, leaded solder containing lead (Pb) components and lead-free solder in which lead components are removed are used. Due to the hazards of the lead components in solder, the proportion of using lead-free solder continues to increase.

However, most lead-free solder inevitably contains tin, and tin necessarily includes a small amount of lead. In addition, there are problems in that the tin itself is expensive compared to leaded solder and has a high melting point of 200° C. or higher, and controlling the shape and size of the bonding is difficult. Furthermore, bismuth or indium added to solve such problems is a rare element and thus expensive.

Hence, in the present disclosure, copper particles are sintered to form bonding, so that an inexpensive copper sintering paste being less hazardous than conventional soldering materials and having high shear strength can be provided.

### DOCUMENT OF RELATED ART

### Patent Document

(Patent Document 1) (0001) Japanese Patent Application No. 2021-073639 (published on 2021 May 13.)
(Patent Document 2) (0002) Japanese Patent Application No. 2021-064612 (published on 2021 Apr. 22.)
(Patent Document 3) (0003) Japanese Patent Application No. 2021-048396 (published on 2021 Mar. 25.)

### Non-Patent Document

(Non-Patent Document 1) (0001) R. Khazaka, L. Mendizabal, D. Henry, Characterization of Nano-silver Dry films for High Temperature Applications, J. ElecTron. Mater. 43(7), 2014, 2459-2466.

### SUMMARY OF THE INVENTION

The present disclosure relates to a copper sintering paste composition for copper sinter bonding. In the present disclosure, copper nanoparticles in which a polymer is capped to chemically protect the copper nanoparticles are provided, and the copper sintering paste composition containing the polymer-capped copper nanoparticles is prepared. As a result, the copper sintering paste composition can replace bonding materials such as leaded solder and lead-free solder while having excellent heat resistance, heat-generating properties, thermal conductivity, and bonding strength.

The present disclosure relates to a copper sintering paste composition containing copper nanoparticles capped with a polymer.

The copper sintering paste composition may include: the polymer-capped copper nanoparticles, a solvent, a reducing agent, a defoaming agent, and a viscosity modifier.

The polymer-capped copper nanoparticles may refer to a component prepared by removing an oxide film of the copper nanoparticles and then capping the surface of the copper nanoparticles with the polymer. In this case, the polymer-capped copper nanoparticles may have an average particle size in a range of 0.5 μm to 5 μm.

The polymer may be any one or a mixture of two or more selected from the group consisting of polyvinylpyrrolidone, polyethylene oxide, polyamide, polymethacrylate, polyacrylate, polyester, polyurethane, and the like, or a copolymer thereof.

The oxide film of the copper nanoparticles may be removed using an oxide film remover. In this case, the oxide film remover is a material capable of forming a copper salt by causing a reaction with a copper oxide (CuO) film. The polymer-capped copper nanoparticles may be prepared by coupling a polymerization initiator to the oxide film-free surface of the copper nanoparticles and then forming the polymer.

The oxide film remover may be an aqueous solution containing at least one selected from among NH₄Cl, NH₄NO₃, and (NH₄)₂SO₄.

The polymerization initiator may be a disulfide.

The solvent, the reducing agent, the defoaming agent, and the viscosity modifier may be vaporized or decomposed when exposed to a temperature in a range of 200° C. to 300° C.

The polymer-capped copper nanoparticles may have 60% to 70% by weight of a non-volatile phase.

The solvent may be any one or a mixture of two or more selected from the group consisting of methyl carbitol, butyl carbitol, dimethyl succinate, dipropylene glycol, 2-(2-hexyloxyethoxy) ethanol, diethylene glycol monobutyl ether acetate, ethylene glycol monohexyl ether, and the like.

The reducing agent may include any one, or two or more selected from the group consisting of oxalic acid, malonic acid, oleic acid, pimelic acid, suberic acid, sebacic acid, fumaric acid, myristic acid, palmitic acid, stearic acid, glutaric acid, maleic acid, azelaic acid, abietic acid, adipic acid, ascorbic acid, acrylic acid, and citric acid.

The defoaming agent may include any one or two selected from the group consisting of polypropylene glycol and polyethylene glycol.

A method of preparing a copper sintering paste composition, provided herein, may include: removing an oxide film on the surface of copper nanoparticles using an oxide film remover; coupling a polymerization initiator to the oxide film-free surface of the copper nanoparticles; polymerizing a polymer monomer on the polymerization initiator-coupled surface of the copper nanoparticles to prepare polymer-capped copper nanoparticles; and mixing the polymer-capped copper nanoparticles in a mixed solution.

As described above, the oxide film remover may be an aqueous solution containing at least one selected from among NH₄Cl, NH₄NO₃, and (NH₄)₂SO₄, and the polymerization initiator may be a disulfide.

In addition, the mixed solution may include a solvent having a high boiling point, a reducing agent, a defoaming agent, and a viscosity modifier.

In addition, copper sinter bonding may be formed by applying the copper sintering paste composition on a substrate, positioning a device on the copper sintering paste composition, and maintaining a temperature in a range of 200° C. to 400° C. for 1 minute to 10 minutes.

A copper sintering paste composition, according to the present disclosure, does not contain lead yet has excellent heat-generating properties, thermal conductivity, bonding strength, and electric conductivity, thereby providing a device-bonding technique capable of replacing conventional lead-free solder.

### BRIEF DESCRIPTION OF THE DRAWINGS

FIG. 1 is a graph showing the results of measuring shear strength of copper sinter bonding formed according to an embodiment of the present disclosure.

### DESCRIPTION OF THE PREFERRED EMBODIMENTS

Hereinafter, a copper sintering paste for copper sinter bonding and a method of preparing the paste, according to the present disclosure, will be described in detail. The drawings introduced below are provided as examples so that the spirit of the present disclosure can be sufficiently conveyed to those skilled in the art. Thus, the present disclosure may be embodied in other forms without being limited to the drawings presented below, and the drawings presented below may be exaggerated to clarify the spirit of the present disclosure. Unless otherwise defined, all terms including technical and scientific terms used herein have the same meaning as commonly understood by those skilled in the art to which the present disclosure belongs. In addition, in the following description of the present disclosure, detailed descriptions of known functions and configurations which are deemed to make the gist of the present disclosure obscure will be omitted.

The present disclosure relates to a copper sintering paste composition, which includes: copper nanoparticles capped with a polymer; a solvent; a reducing agent; a defoaming agent; and a viscosity modifier.

In this case, the polymer-capped copper nanoparticles may mean a component prepared by removing an oxide film of the copper nanoparticles and then capping the surface of the copper nanoparticles with the polymer. The copper nanoparticles may have an average particle size in a range of 0.5 μm to 5 μm, preferably in the range of 1 μm to 3 μm. As the copper nanoparticles having such sizes are used, an excellent bonding strength of 15 MPa or higher may be exhibited when forming copper bonding later.

The polymer may be any one or a mixture of two or more selected from the group consisting of polyvinylpyrrolidone polyethylene oxide, and the like, or a copolymer thereof. In this case, the polymer may be included in 1 part to 5 parts by weight with respect to 100 parts by weight of the copper nanoparticles.

The oxide film of the copper nanoparticles may be removed using an oxide film remover. Specifically, the oxide film remover, which is a material capable of causing a reaction with a copper oxide (CuO) film to form a copper salt, is not particularly limited as long as it is preferably an ammonium salt. Specifically, the oxide film remover may be an aqueous solution including ammonium salts, such as NH₄Cl, NH₄NO₃, (NH₄)₂SO₄, and the like. In addition, the oxide film remover is preferably mixed in an aqueous ammonia solution for use so that the copper oxide film can be easily removed.

The oxide film remover and the aqueous ammonia solution may be mixed in a weight ratio in a range of 1:0.5 to 1:2. When the amount of the oxide film remover is smaller than the amount of the aqueous ammonia solution, the oxide film may fail to be completely removed, making the capping of the polymer difficult. On the contrary, when the amount of the oxide film remover is greater than the amount of the aqueous ammonia solution, copper may be excessively dissolved, leading to an increase in the consumption of the copper nanoparticles.

The polymer-capped copper nanoparticles may be obtained by removing the oxide film on the surface of the copper nanoparticles using the oxide film remover, coupling a polymerization initiator to the oxide film-free surface of the copper nanoparticles, and polymerizing a polymer monomer on the polymerization initiator-coupled surface of the copper nanoparticles.

Such a polymer may be chemically bonded to the metal surface and may be capped by polymerizing a monomer with the addition of a material capable of serving as a polymer initiator. For example, a disulfide-based initiator, such as [S—CH₂CH₂OCOC(CH₃)₂Br]₂ or [S—(CH₂)₁₁OCOC(CH₃)₂Br]₂ containing a thiol group, is preferably used. As such an initiator is used, the polymerization of the monomer and the capping of the surface, in which the polymer is chemically bonded to the surface of the copper nanoparticles, may be performed.

In this case, the density of the polymer to be polymerized may be controlled according to the treatment time of the initiator. The longer the treatment time, the higher the density of the polymer to be polymerized.

The monomer may be selected from monomers capable of forming the aforementioned polymer, and vinyl pyrrolidone is preferably used.

The solvent, the reducing agent, the defoaming agent, and the viscosity modifier may be vaporized or decomposed when exposed to a temperature in a range of 200° C. to 300° C. As such materials are used, no residual organic materials remain during the formation of the bonding, and the shear strength of the bonding thus can be highly maintained.

The polymer-capped copper nanoparticles may have 60% to 70% by weight of a non-volatile phase. When the content of the non-volatile phase in the polymer-capped copper nanoparticles is higher than the above numerical range, the viscosity of the paste may be extremely high. On the contrary, when the content of the non-volatile phase of the polymer-capped copper nanoparticles is lower than the above numerical range, the viscosity of the paste is extremely low, and there may be a problem in that the sinter bonding is poor.

The copper sintering paste composition, according to the present disclosure, may include: 1 part to 5 parts by weight of the reducing agent; 0.5 parts to 1.5 parts by weight of the viscosity modifier; 0.5 parts to 1.5 parts by weight of an additive; 0.5 parts to 1.5 parts by weight of the defoaming agent; and 40 parts to 60 parts by weight of the solvent, with respect to 100 parts by weight of the polymer-capped copper nanoparticles. The composition, prepared in such ranges, has an appropriate viscosity and is thus advantageous to a semiconductor process.

The solvent is preferably an organic solvent having a high boiling point. Specifically, any organic solvent having a boiling point of 150° C. or higher may be used. For example, the solvent may be any one or a mixture of two or more selected from the group consisting of methyl carbitol, butyl carbitol, dimethyl succinate, dipropylene glycol, 2-(2-hexyloxyethoxy) ethanol, diethylene glycol monobutyl ether acetate, ethylene glycol monohexyl ether, and the like. As such a solvent is used, the solvent may not be volatilized easily at room temperature while being volatilized at high temperatures during the bonding formation, which is preferable. However, when using an organic solvent having a boiling point higher than 240° C., the solvent is unlikely to be volatilized as described above, which is undesirable.

The reducing agent may include any one, or two or more selected from the group consisting of oxalic acid, malonic acid, oleic acid, pimelic acid, suberic acid, sebacic acid, fumaric acid, myristic acid, palmitic acid, stearic acid, glutaric acid, maleic acid, azelaic acid, abietic acid, adipic acid, ascorbic acid, acrylic acid, and citric acid. In this case, oxalic acid is preferably used. As such an organic acid-based material is used, the reducing agent may be thermally decomposed at high temperatures during the bonding formation. Thus, the residual amount is small, which is preferable.

The defoaming agent may include any one or two selected from the group consisting of polypropylene glycol and polyethylene glycol. As such a defoaming agent is used, the formation of bubbles may be prevented in the paste. In addition, the bonding strength of the sinter bonding can be further increased.

As the viscosity modifier, a mixture of a cellulose-based or acrylic acid-based material and an amine-based material may be used. Specifically, materials, such as hydroxypropyl methylcellulose or hydroxyethyl methylcellulose, may be appropriately used as the cellulosic viscosity modifier. A material used as existing thickeners, such as carbopol 940, may be appropriately used as the acrylic acid-based material. In addition, a material, such as triethylamine, may be appropriately used as the amine-based material to be mixed with the cellulose-based or acrylic acid-based material. As such materials are added, the viscosity of the copper sintering paste can be kept suitable for the semiconductor process.

The copper sintering paste may further include a silane coupling agent as the additive. Specifically, the silane coupling agent may mean an ethoxy-based or methoxy-based silane coupling agent, such as vinyltrimethoxysilane, vinyltriethoxysilane, N-2-(aminoethyl)-3-aminopropyltrimethoxysilane, 3-methacryloxypropyltrimethoxysilane, and 3-mercaptopropyltrimethoxysilane. As such an additive is included, the dispersion of the particles in the paste may be increased, thereby uniformly forming the bonding during the sintering.

A method of preparing a copper sintering paste composition, according to the present disclosure, may include: removing an oxide film on the surface of copper nanoparticles using an oxide film remover; coupling a polymerization initiator to the oxide film-free surface of the copper nanoparticles; polymerizing a polymer monomer on the polymerization initiator-coupled surface of the copper nanoparticles to prepare polymer-capped copper nanoparticles; and mixing the polymer-capped copper nanoparticles in a mixed solution.

In the case where the materials fail to be uniformly dispersed during the mixing, the bonding strength may be decreased when forming copper bonding later, resulting in breakage in the bonding.

The mixed solution includes the solvent having a high boiling point, the reducing agent, the defoaming agent, and the viscosity modifier as described above. Since the oxide film remover and the polymerization initiator are the same as those described above, duplicate descriptions will be omitted.

Copper sinter bonding may be formed by applying such a copper sintering paste composition on a substrate, positioning a device on the copper sintering paste composition, and then maintaining a temperature in a range of 200° C. to 400° C. for 1 minute to 10 minutes.

In addition, the method of forming the copper sinter boding, as described above, may further include a preheating process performed within 1 minute. Such a preheating process may be performed within 2 minutes at a temperature in a range of 100° C. to 200° C. As such a preheating process is involved, the rapid gas generation, caused by a change in temperature during the bonding of a small electric device, can be prevented, so a further precise process is enabled.

The copper sinter bonding formed from the copper sintering paste, as described above, may have a shear strength in a range of 10 MPa to 25 MPa.

Hereinafter, a copper sintering paste and a copper sinter bonding formed from the paste, according to the present invention, will be described in more detail with reference to Examples. Unless otherwise defined, all terms including technical and scientific terms used herein have the same meaning as commonly understood by those skilled in the art to which the present disclosure belongs. The terms used in the specification are only to effectively describe a specific Example, but are not to limit the present disclosure.

[Removal of Oxide Film of Copper Nanoparticles]

1 L of a mixed solution in which 2 g of (NH₄)₂SO₄ and 1 g of NH₄OH, used as oxide film removers, were mixed in distilled water was added to a semi-batch thermostatic reactor. Then, while adding 10 g of copper nanoparticles, the mixed solution was heated to a temperature of 40° C. with stirring to cause a reaction for 10 minutes. An oxide film of the copper nanoparticles was removed, the mixed solution was filtered, and the resulting copper nanoparticles were dried to obtain oxide film-free copper nanoparticles.

[Preparation of Polymer-Capped Copper Nanoparticles]

150 μL of disulfide ([S—(CH₂)₁₁OCOC(CH₃)₂Br]₂) and 200 mL of tetrahydrofuran (THF, manufactured by Sigma Aldrich), used as polymer initiators, were added to a 500 mL round-bottom flask and stirred vigorously while slowly adding the oxide film-free copper nanoparticles thereto. The copper nanoparticles were obtained by centrifugation, after stirring the mixture at a temperature of 20° C. for 24 hours, and the obtained copper nanoparticles were then dispersed in N,N-dimethylformamide (DMF). Thereafter, 0.5 g of 4-vinylpyridine (4VP) and 0.5 mL of distilled water were added to the flask under a nitrogen atmosphere with vigorous stirring for 48 hours at a temperature of 40° C. to induce polymerization. As a result, the surface of the copper nanoparticles was capped with PVP, and the mixed solution was then filtered to obtain PVP-capped copper nanoparticles.

### Example 1

65 g of the PVP-capped copper nanoparticles were mixed in 30 g of butyl carbitol with stirring while 2 g of a reducing agent, 0.5 g of a viscosity modifier, and 0.5 g of an additive were added for 2 hours to prepare a copper sintering paste composition.

### Comparative Example 1

A copper sintering paste composition was prepared in the same manner as in Example 1, except that the copper nanoparticles not involving the PVP capping were used.

[Method of Evaluating Properties]

Measurement of Shear Strength

Copper sinter bonding was formed from the copper sintering paste, and the shear strength of the bonding was measured.

TABLE 1

| Sinter-bonding | Shear strength (MPa) | |
|---|---|---|
| time (minute) | Example 1 | Comparative Example 1 |
| 1 | 10.89 ± 1.74 | 7.21 ± 0.40 |
| 3 | 16.05 ± 1.85 | 7.81 ± 0.98 |
| 5 | 21.03 ± 2.96 | 8.33 ± 1.12 |
| 10 | 18.27 ± 4.11 | 11.43 ± 2.16 |

Bonding conditions: 300° C. and 5 MPa
Preheating was performed in Example 1 at a temperature of 150° C. for 30 seconds to prevent sputtering.

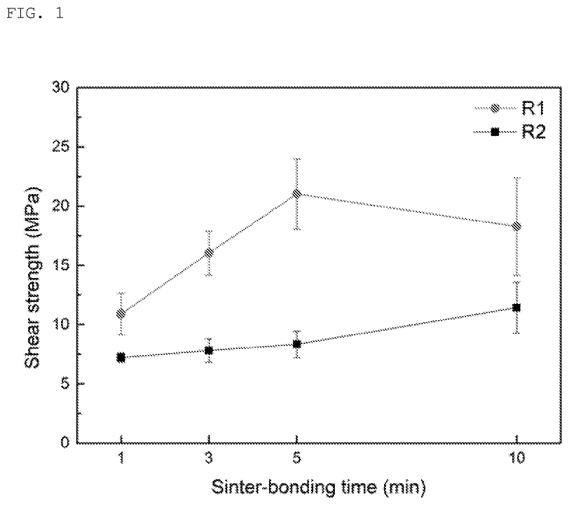

The shear strength of the bonding formed in Example 1 and Comparative Example 1 can be visually confirmed with reference to FIG. 1. In the case of Example 1, the shear strength increased in proportion to the sinter bonding time. In addition, the highest shear strength was exhibited when performing the sinter bonding for 5 minutes. In the case of performing the sinter bonding for more than 5 minutes, the shear strength tended to decrease gradually, confirming that the optimal sintering time in Example 1 was in a range of 3 minutes to 8 minutes. On the other hand, in the case of Comparative Example 1, even though the shear strength increased as the sinter bonding time increased, it was seen that the shear strength was generally lower than that of Example 1.

In addition, in the case of Example 1 involving the PVP capping, a rather large variation in shear strength tended to be exhibited. However, when performing the sinter bonding within 10 minutes, the shear strength was generally excellent, which hardly affects quality.

Although the present disclosure is described with reference to specific details and merely some embodiments, such specific details disclosed herein are merely representative for purposes of helping comprehensive understanding of the present disclosure. The present disclosure is not limited to only the exemplary embodiments set forth herein, and those skilled in the art will appreciate that the present disclosure can be modified in many different forms. Therefore, the present disclosure is intended to cover not only the exemplary embodiments, but also various alternatives, modifications, equivalents, and other embodiments that may be included within the spirit and scope of the present disclosure as defined by the appended claims.

What is claimed is:

1. A copper sintering paste composition comprising:
polymer-capped copper nanoparticles;
a solvent;
a reducing agent;
a defoaming agent; and
a viscosity modifier.

2. The composition of claim 1, wherein the polymer-capped copper nanoparticles have an average particle size in a range of 0.5 μm to 5 μm.

3. The composition of claim 1, wherein the polymer is at least one selected from among polyvinylpyrrolidone and polyethylene oxide.

4. The composition of claim 1, wherein the polymer-capped copper nanoparticles are prepared by removing an oxide film on the surface of the copper nanoparticles using an oxide film remover and then coupling a polymerization initiator to the oxide film-free surface of the copper nanoparticles to form the polymer.

5. The composition of claim 4, wherein the oxide film remover is an aqueous solution comprising at least one selected from among NH₄Cl, NH₄NO₃, and (NH₄)₂SO₄.

6. The composition of claim 4, wherein the polymerization initiator is a disulfide.

7. The composition of claim 1, wherein the solvent, the reducing agent, the defoaming agent, and the viscosity modifier are vaporized or decomposed when exposed to a temperature in a range of 200° C. to 300° C.

8. The composition of claim 1, wherein the polymer-capped copper nanoparticles comprise 60% to 70% by weight of a non-volatile phase.

9. The composition of claim 1, wherein the solvent is any one or a mixture of two or more selected from the group consisting of methyl carbitol, butyl carbitol, dimethyl succinate, dipropylene glycol, 2-(2-hexyloxyethoxy)ethanol, diethylene glycol monobutyl ether acetate, and ethylene glycol monohexyl ether.

10. The composition of claim 1, wherein the reducing agent comprises any one, or two or more selected from the group consisting of oxalic acid, malonic acid, oleic acid, pimelic acid, suberic acid, sebacic acid, fumaric acid, myristic acid, palmitic acid, stearic acid, glutaric acid, maleic acid, azelaic acid, abietic acid, adipic acid, ascorbic acid, acrylic acid, and citric acid.

11. The composition of claim 1, wherein the defoaming agent comprises at least one selected from among polypropylene glycol and polyethylene glycol.

12. A method of preparing a copper sintering paste composition, the method comprising:
removing an oxide film on the surface of copper nanoparticles using an oxide film remover;
coupling a polymerization initiator to the oxide film-free surface of the copper nanoparticles;
polymerizing a polymer monomer on the polymerization initiator-coupled surface of the copper nanoparticles to prepare polymer-capped copper nanoparticles; and
mixing the polymer-capped copper nanoparticles in a mixed solution.

13. The method of claim 12, wherein the oxide film remover is an aqueous solution comprising at least one selected from among NH₄Cl, NH₄NO₃, and (NH₄)₂SO₄.

14. The method of claim 12, wherein the polymerization initiator is a disulfide.

15. The method of claim 12, wherein the mixed solution comprises a solvent having a high boiling point, a reducing agent, a defoaming agent, and a viscosity modifier.
